(19) United States
(12) Patent Application Publication
(10) Pub. No.: US 2021/0054243 A1
(43) Pub. Date: Feb. 25, 2021

(54) DOUBLE-SIDED ADHESIVE SHEET AND DOUBLE-SIDED ADHESIVE SHEET WITH RELEASE SHEET(S)

(71) Applicant: OJI HOLDINGS CORPORATION, Tokyo (JP)

(72) Inventors: Jiro SHIMIZU, Tokyo (JP); Nobuyuki IWASAKI, Kagawa (JP); Yoshiharu NISHIKORI, Tokyo (JP); Jun SHIONO, Tokyo (JP)

(73) Assignee: OJI HOLDINGS CORPORATION, Tokyo (JP)

(21) Appl. No.: 16/963,103

(22) PCT Filed: Jan. 18, 2019
(86) PCT No.: PCT/JP2019/001438

§ 371 Date: Jul. 17, 2020

(30) Foreign Application Priority Data
Jan. 18, 2018 (JP) 2018-006188
Jul. 4, 2018 (JP) 2018-127577
Sep. 11, 2018 (JP) 2018-169436

(51) Int. Cl. C09J 7/38; C09J 7/10; C09J 7/40; B32B 7/06; B32B 7/12; B32B 27/10; B32B 27/30; B32B 27/28

(52) U.S. Cl. CPC C09J 7/385; C09J 7/10; C09J 7/405; B32B 7/06; B32B 7/12; B32B 27/10; B32B 2405/00; B32B 27/28; C09J 2301/302; C09J 2301/208; C09J 2433/00; C09J 2483/00; B32B 27/308

(57) ABSTRACT

It is an object of the present invention to provide a double-sided adhesive sheet having strong adhesive force and excellent reworkability. The present invention relates a double-sided adhesive sheet having an acrylic adhesive layer and a silicone adhesive layer directly laminated on the acrylic adhesive layer, wherein the interfacial adhesive force between the acrylic adhesive layer and the silicone adhesive layer is 1 N/25 mm or more.

### TECHNICAL FIELD

The present invention relates to a double-sided adhesive sheet and a double-sided adhesive sheet with a release sheet(s).

### BACKGROUND ART

In recent years, display devices such as a liquid crystal display (LCD), or image display devices such as touch panels, in which a display device is combined with an input device, have been widely used. In these display devices or input devices, a double-sided adhesive sheet is used for laminating an optical member on the devices.

The double-sided adhesive sheet is used to laminate different types of adherents on each other in some cases. In this case, the double-sided adhesive sheet is required to have optimal adhesive force, which depends on the adhesive properties of each adherent. For example, Patent Documents 1 and 2 disclose a double-sided adhesive sheet comprising two or more adhesive layers having different adhesive properties.

In display devices or input devices, the surface is covered with a protective sheet in order to protect the display surface. Such a protective sheet is composed of, for example, a glass sheet comprising an adhesive layer, and cracks or scratches of the liquid crystal display are suppressed by laminating the protective sheet on the display surface. In the case of using such a protective sheet, for correction of the laminating position or the exchange of the protective sheet with another one due to deterioration over time, the protective sheet needs to be reworked (removed) in some cases. For example, Patent Documents 3 and 4 disclose a double-sided adhesive sheet having at least two adhesive layers, which is configured to be removable from the display surface of a display device. In the Examples of Patent Document 3, individual adhesive layers were formed from different types of acrylic polymers, and thereby, it was studied to increase the durability and reworkability of a double-sided adhesive sheet. Besides, the double-sided adhesive sheet of Patent Document 3 is aimed at the attachment of a display surface to a touch panel. Moreover, Patent Document 4 discloses a double-sided adhesive sheet having a first adhesive layer and a second adhesive layer on both surfaces of a core, wherein a silicone adhesive is used for a first adhesive layer, whereas an acrylic adhesive is used for a second adhesive layer.

### PRIOR ART DOCUMENTS

### Patent Documents

Patent Document 1: Japanese Patent Publication No. H5-17725 (1993) A
Patent Document 2: Japanese Patent Publication No. 2011-57883 A
Patent Document 3: Japanese Patent Publication No. 2004-231723 A
Patent Document 4: Japanese Patent No. 6197102

### SUMMARY OF INVENTION

### Object to be Solved by the Invention

However, the double-sided adhesive sheet of the prior art has been problematic in that, when the sheet is removed from an adherend, the adhesive remains on the adherent upon the reworking operation. When the adhesive remains on the adherent, it is necessary to wipe off or wash off the adhesive with a solvent, and thus, it is problematic in that considerable labor and time are required for the reworking operation. In particular, a protective sheet, for which attachment or reworking operation is carried out by a general consumer who cannot use special devices, jigs or drugs, needs to be easily reworked from a display surface. Accordingly, the adhesive force of the protective sheet to the display surface needs to be set at extremely low. On the other hand, a double-sided adhesive sheet used for such a protective sheet needs to strongly adhere to an adhesion target on the side opposite to the display surface. In general, since it is difficult to laminate adhesive layers having such incompatible adhesive properties on each other, a double-sided adhesive sheet having a base film between a slightly adhesive layer and a strong adhesive layer has been used. However, the thickness of such a double-sided adhesive sheet having a base film between a slightly adhesive layer and a strong adhesive layer tends to increase, and thus, it has been problematic in that unevenness followability is deteriorated, or in that it cannot satisfy the current demand for film thinning.

Hence, in order to solve the aforementioned problems of the prior art techniques, the present inventors have conducted studies for the purpose of providing a double-sided adhesive sheet, one surface of which exhibits strong adhesive force to an adherent, while other surface can exhibit excellent reworkability, wherein the double-sided adhesive sheet does not comprise a base film.

### Means for Solving the Object

As a result of intensive studies directed towards achieving the aforementioned object, the present inventors have found that a double-sided adhesive sheet having both strong adhesive force and excellent reworkability, which does not comprise a base film, can be obtained by directly laminating a silicone adhesive layer on an acrylic adhesive layer and also setting the interfacial adhesive force between the acrylic adhesive layer and the silicone adhesive layer to be a predetermined value or greater.

Specifically, the present invention has the following configuration.

[1] A double-sided adhesive sheet having:

an acrylic adhesive layer, and

a silicone adhesive layer directly laminated on the acrylic adhesive layer, wherein

the interfacial adhesive force between the acrylic adhesive layer and the silicone adhesive layer is 1 N/25 mm or more.

[2] The double-sided adhesive sheet according to [1], wherein

the acrylic adhesive layer has an acrylic copolymer comprising a unit derived from butyl acrylate, and

the content of the butyl acrylate-derived unit is 30% by mass or more with respect to the total mass of the acrylic copolymer.

[3] The double-sided adhesive sheet according to [2], wherein

the acrylic copolymer further comprises a unit derived from 2-hydroxyethyl acrylate, and

the content of the 2-hydroxyethyl acrylate is 10% by mass or more and 50% by mass or less, with respect to the total mass of the acrylic copolymer.

[4] The double-sided adhesive sheet according to [2], wherein

the acrylic copolymer further comprises a unit derived from 2-methoxyethyl acrylate, and

the content of the 2-methoxyethyl acrylate-derived unit is 10% by mass or more and 50% by mass or less, with respect to the total mass of the acrylic copolymer.

[5] The double-sided adhesive sheet according to any one of [2] to [4], wherein the acrylic copolymer further comprises at least one type selected from a unit derived from 2-ethylhexyl acrylate and a unit derived from acrylic acid.
[6] The double-sided adhesive sheet according to any one of [1] to [5], wherein at least one selected from the surface of the acrylic adhesive layer on the interface side and the surface of the silicone adhesive layer on the interface side is a surface-activation-treated surface.
[7] The double-sided adhesive sheet according to any one of [1] to [6], wherein the surface of the acrylic adhesive layer on the interface side is a surface-activation-treated surface, and the wetting tension of the surface-activation-treated surface is 70 mN/m or more.
[8] The double-sided adhesive sheet according to any one of [1] to [7], wherein the surface of the silicone adhesive layer on the interface side is a surface-activation-treated surface, and the wetting tension of the surface-activation-treated surface is 30 mN/m or more.
[9] The double-sided adhesive sheet according to any one of [1] to [8], wherein

the acrylic adhesive layer comprises a silane coupling agent, and

the content of the silane coupling agent is 0.03% by mass or more and 5% by mass or less, with respect to the total mass of the acrylic adhesive layer.

[10] The double-sided adhesive sheet according to any one of [1] to [9], wherein

the acrylic adhesive layer comprises an acrylic copolymer comprising a unit derived from a nitrogen-containing monomer, and the content of the nitrogen-containing monomer-derived unit is 5% by mass or more and 70% by mass or less, with respect to the total mass of the acrylic copolymer.

[11] The double-sided adhesive sheet according to any one of [1] to [10], wherein the acrylic adhesive layer comprises a hydrogen abstraction type polymerization initiator, and the content of the hydrogen abstraction type polymerization initiator is 0.05% by mass or more and 10% by mass or less, with respect to the total mass of the acrylic adhesive layer.
[12] The double-sided adhesive sheet according to [11], wherein the hydrogen abstraction type polymerization initiator is a photopolymerization initiator.
[13] The double-sided adhesive sheet according to any one of [1] to [12], wherein the adhesive force of the acrylic adhesive layer to a glass is 1 N/25 mm or more.
[14] The double-sided adhesive sheet according to [13], wherein the adhesive force of the acrylic adhesive layer to a glass is 30 N/25 mm or less.
[15] The double-sided adhesive sheet according to any one of [1] to [14], wherein the adhesive force of the silicone adhesive layer to a glass is 0.005 N/25 mm or more and 1 N/25 mm or less.
[16] A double-sided adhesive sheet with release sheets, comprising release sheets on both surfaces of the double-sided adhesive sheet according to any one of [1] to [15].

### Effects of Invention

According to the present invention, a double-sided adhesive sheet, one surface of which exhibits strong adhesive force to an adherent, while other surface can exhibit excellent reworkability, wherein the double-sided adhesive sheet does not comprise a base film, can be obtained.

### BRIEF DESCRIPTION OF DRAWINGS

FIG. 1 is a cross-sectional view showing a configuration of the double-sided adhesive sheet of the present invention.

### EMBODIMENTS OF CARRYING OUT THE INVENTION

Hereinafter, the present invention will be described in detail. The following constituent components may be described based on representative embodiments or specific examples. However, the present invention is not limited to such embodiments.

### (Double-Sided Adhesive Sheet)

The present invention relates to a double-sided adhesive sheet having an acrylic adhesive layer, and a silicone adhesive layer directly laminated on the acrylic adhesive layer, wherein the interfacial adhesive force between the acrylic adhesive layer and the silicone adhesive layer is 1 N/25 mm or more. Since the double-sided adhesive sheet of the present invention has such a plurality of adhesive layers, it can also be referred to as a “double-sided laminated adhesive sheet.”

Since the double-sided adhesive sheet of the present invention has the above-described configuration, it is excellent in terms of reworkability. Herein, excellent reworkability means properties by which when a double-sided adhesive sheet is attached to an adherent and is then removed therefrom, a part of the adhesive of the double-sided adhesive sheet does not remain on the adherent, and the double-sided adhesive sheet does not break during the reworking operation. Furthermore, one surface of the double-sided adhesive sheet of the present invention can exhibit strong adhesive force to the adherent. In particular, the double-sided adhesive sheet of the present invention can exhibit strong adhesive force to a glass surface. Thus, the double-sided adhesive sheet of the present invention has both strong adhesive force and excellent reworkability.

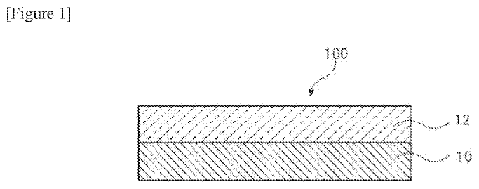

FIG. 1 is a cross-sectional view illustrating a configuration of the double-sided adhesive sheet of the present invention. A double-sided adhesive sheet 100 of the present invention has an acrylic adhesive layer 10 and a silicone adhesive layer 12. As shown in FIG. 1, the double-sided adhesive sheet 100 preferably has a configuration in which a single acrylic adhesive layer 10 and a single silicone adhesive layer 12 are laminated on each other, but the double-sided adhesive sheet 100 may also comprise two or more of the acrylic adhesive layers and two or more of the silicone adhesive layers. For example, the acrylic adhesive layer 10, which is shown as a single layer in FIG. 1, may have a laminated structure consisting of two or more acrylic adhesive layers, or the silicone adhesive layer 12 may have a laminated structure consisting of two or more silicone adhesive layers.

The double-sided adhesive sheet of the present invention is, as shown in FIG. 1, a double-sided adhesive sheet not having a support (base film). As such, in the double-sided adhesive sheet, the acrylic adhesive layer and the silicone adhesive layer are laminated on each other in a state in which they are directly contacted with each other. Hence, the double-sided adhesive sheet of the present invention enables film thinning, as necessary. Moreover, since the double-sided adhesive sheet of the present invention is a double-sided adhesive sheet not having a support (base material), it is excellent in terms of curved surface followability and is further excellent in terms of step followability. It is to be noted that the layer contacted with the step structure may be the acrylic adhesive layer or the silicone adhesive layer.

Since the double-sided adhesive sheet of the present invention has the above-described configuration, it also has good air release properties to the display surface. In the present description, air release properties mean properties by which air bubbles do not remain at the interface between an adhesive layer and an adherent, when a double-sided adhesive sheet is attached to the adherent. Further, the double-sided adhesive sheet of the present invention is also excellent in terms of unevenness followability. Thus, the double-sided adhesive sheet of the present invention can be attached to an adherent having a relief structure (step structure). The layer contacted with the relief structure (step structure) may be either the acrylic adhesive layer or the silicone adhesive layer.

In the double-sided adhesive sheet of the present invention, the interfacial adhesive force between the acrylic adhesive layer and the silicone adhesive layer is preferably 1 N/25 mm or more, more preferably 5 N/25 mm or more, further preferably 10 N/25 mm or more, and particularly preferably 15 N/25 mm or more. The upper limit value of the interfacial adhesive force between the acrylic adhesive layer and the silicone adhesive layer is not particularly limited, and for example, it is preferably 100 N/25 mm. In view of the foregoing, in the double-sided adhesive sheet of the present invention, the acrylic adhesive layer and the silicone adhesive layer strongly adhere to each other, and these layers are excellent in terms of interlayer adhesiveness. By setting the interfacial adhesive force between the acrylic adhesive layer and the silicone adhesive layer to be within the above-described range, peeling occurring between the acrylic adhesive layer and the silicone adhesive layer when the double-sided adhesive sheet is reworked can be suppressed, and as a result, reworkability can be enhanced.

As described in the Examples later, the interfacial adhesive force between the acrylic adhesive layer and the silicone adhesive layer can be measured, after a sample for the measurement of the interfacial adhesive force has been produced.

As described in the Examples later, with regard to the measurement of interfacial adhesive force, at 24 hours after the “polyethylene terephthalate film with highly adhesive layer/acrylic adhesive layer/silicone adhesive layer/adhesive tape with base material for lining” has been obtained (i.e., at 24 hours after the surface of the silicone adhesive layer subjected to a surface activation treatment and the surface of the acrylic adhesive layer subjected to a surface activation treatment have been attached to each other), the side of the adhesive tape with a base material for lining is peeled in accordance with Method 1 of JIS Z 0237, under conditions of a peeling rate of 300 mm/min and a peeling angle of 180°, so as to measure the adhesive force at the interface between the “acrylic adhesive layer/silicone adhesive layer.”

The adhesive force of one surface side of the double-sided adhesive sheet of the present invention to a glass is preferably 1 N/25 mm or more, more preferably 5 N/25 mm or more, and further preferably 10 N/25 mm or more. On the other hand, the adhesive force of one surface side of the double-sided adhesive sheet to a glass is preferably 50 N/25 mm or less, and more preferably 30 N/25 mm or less. The above-described adhesive force is preferably the adhesive force on the side of the acrylic adhesive layer in the double-sided adhesive sheet, and the adhesive force of the acrylic adhesive layer to a glass is preferably within the above-described range.

In addition, the adhesive force of the other surface side of the double-sided adhesive sheet of the present invention to a glass is preferably 0.005 N/25 mm or more, and more preferably 0.05 N/25 mm or more. On the other hand, the adhesive force of the other surface side of the double-sided adhesive sheet to a glass is preferably 1.0 N/25 mm or less, and more preferably 0.5 N/25 mm or less. The above-described adhesive force is preferably the adhesive force on the side of the silicone adhesive layer in the double-sided adhesive sheet, and the adhesive force of the silicone adhesive layer to a glass is preferably within the above-described range.

It is to be noted that the adhesive force of the double-sided adhesive sheet to a glass is a value measured in accordance with Method 1 of JIS Z 0237, under conditions of a peeling rate of 300 mm/min and a peeling angle of 180°, at 24 hours after the adhesive surface of each adhesive layer has been attached to a soda-lime glass. By setting the adhesive force of each adhesive layer to the glass to be within the above-described range, a double-sided adhesive sheet having both strong adhesive force and excellent reworkability can be obtained.

The entire thickness of the double-sided adhesive sheet of the present invention is preferably 10 μm or more, more preferably 20 μm or more, and further preferably 50 μm or more. On the other hand, the entire thickness of the double-sided adhesive sheet is preferably 1000 μm or less, more preferably 800 μm or less, and further preferably 600 μm or less. By setting the entire thickness of the double-sided adhesive sheet to be within the above-described range, both strong adhesive force and excellent reworkability can be easily achieved.

The thickness of a single acrylic adhesive layer in the double-sided adhesive sheet of the present invention is preferably 5 μm or more, more preferably 10 μm or more, and further preferably 25 μm or more. On the other hand, the thickness of the single acrylic adhesive layer is preferably 500 μm or less, more preferably 400 μm or less, and further preferably 300 μm or less.

The thickness of a single silicone adhesive layer in the double-sided adhesive sheet of the present invention is preferably 5 μm or more, more preferably 10 μm or more, and further preferably 25 μm or more. On the other hand, the thickness of the single silicone adhesive layer is preferably 500 μm or less, more preferably 400 μm or less, and further preferably 300 μm or less.

In the present invention, when the thickness (μm) of the acrylic adhesive layer is defined as P and the thickness (μm) of the silicone adhesive layer is defined as Q, P: Q is preferably 1:10 to 10:1. By setting P:Q to be within the above-described range, a double-sided adhesive sheet, one surface of which exhibits strong adhesive force to an adherent, while the other surface can exhibit excellent reworkability, is easily obtained. Besides, when the double-sided adhesive sheet comprises two or more acrylic adhesive layers, the aforementioned P indicates the sum of the thicknesses of the acrylic adhesive layers. When the double-sided adhesive sheet comprises two or more silicone adhesive layers, the aforementioned Q indicates the sum of the thicknesses of the silicone adhesive layers.

The haze of the double-sided adhesive sheet of the present invention is preferably 3% or less, and more preferably 1% or less. In the present description, the haze of the double-sided adhesive sheet is a value measured by the method in accordance with JIS K 7136. Upon the measurement of the haze, the haze value is measured while the double-sided adhesive sheet of the present invention is laminated onto a slide glass (product number: S9112) manufactured by Matsunami Glass Ind., Ltd. Specifically, after the double-sided adhesive sheet has been laminated onto the slide glass manufactured by Matsunami Glass Ind., Ltd., the laminated sample is subjected to an autoclave (pressurized defoaming) treatment under conditions of 0.5 MPa and 40° C., in order to eliminate fine air, etc. mixed upon the lamination. Thereafter, a release sheet on the surface opposite to the glass-laminated surface is peeled, and the thus exposed glue surface is measured using NDH4000 manufactured by NIPPON DENSHOKU INDUSTRIES CO., LTD.

The total light transmittance of the double-sided adhesive sheet of the present invention is preferably 80% or more, more preferably 85% or more, and further preferably 90% or more. The double-sided adhesive sheet of the present invention is characterized in that it has high total light transmittance and is excellent in terms of transparency. In the present description, the total light transmittance of a double-sided adhesive sheet is a value measured by the method in accordance with JIS K 7136. The total light transmittance of the double-sided adhesive sheet can be measured by the same method as the aforementioned method for measuring a haze value.

Moreover, the double-sided adhesive sheet of the present invention is also excellent in terms of flexibility. Thus, even if the adherent is a member having a curved surface or a step part, the present double-sided adhesive sheet can be attached to the adherent, while following the curved surface or the step part thereof.

### <Acrylic Adhesive Layer>

The double-sided adhesive sheet of the present invention comprises an acrylic adhesive layer. The acrylic adhesive layer is a layer comprising, as a main component, an acrylic resin, preferably an acrylic copolymer. Specifically, the content of the acrylic resin (acrylic copolymer) in the acrylic adhesive layer is preferably 50% by mass or more, more preferably 60% by mass or more, further preferably 70% by mass or more, still further preferably 80% by mass or more, and particularly preferably 90% by mass or more, with respect to the total mass of the acrylic adhesive layer.

The acrylic resin may be, for example, an acrylic adhesive comprising an acrylic polymer as a base polymer. The acrylic polymer preferably comprises a non-crosslinkable (meth)acrylic acid ester unit, and at least one of an acrylic monomer unit having a crosslinkable functional group and a bifunctional acrylic monomer unit. Herein, the “monomer unit” is a repeating unit that constitutes a polymer. The “acrylic monomer” is a compound having a (meth)acryloyl group. The “(meth)acryloyl group” indicates an acryloyl group or a methacryloyl group. In addition, the non-crosslinkable acrylic monomer is an acrylic monomer not having a crosslinkable group, whereas the crosslinkable acrylic monomer is a monomer having a crosslinkable group. The crosslinkable acrylic monomer may be either an acrylic monomer or a non-acrylic monomer, as long as it is polymerizable with a non-crosslinkable acrylic monomer. The crosslinkable acrylic monomer is preferably an acrylic monomer. Examples of the crosslinkable group may include a carboxy group, a hydroxy group, an amino group, an epoxy group, and a glycidyl group.

The non-crosslinkable acrylic monomer unit may be, for example, a (meth)acrylic acid ester unit, in which a hydrogen atom of the carboxy group of (meth)acrylic acid is substituted with a hydrocarbon atom. In the present invention, the acrylic adhesive layer preferably comprises a (meth)acrylic acid ester unit.

Specific examples of the (meth)acrylic acid ester may include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, n-pentyl (meth)acrylate, n-hexyl (meth)acrylate, 2-ethylhexyl (meth)acrylate, n-octyl (meth)acrylate, isooctyl (meth)acrylate, n-nonyl (meth)acrylate, isobornyl (meth)acrylate, isononyl (meth)acrylate, n-decyl (meth)acrylate, isodecyl (meth)acrylate, n-undecyl (meth)acrylate, n-dodecyl (meth)acrylate, stearyl (meth)acrylate, methoxyethyl (meth)acrylate, ethoxyethyl (meth)acrylate, cyclohexyl (meth)acrylate, and benzyl (meth)acrylate. Among these, in terms of adhesiveness, n-butyl acrylate, 2-ethylhexyl acrylate, and methyl acrylate are preferably used. These (meth)acrylic acid esters may be used alone as a single type, or may also be used in combination of two or more types. It is to be noted that, in the present invention, the term “(meth)acrylic acid” is used to include both “acrylic acid” and “methacrylic acid.”

Examples of the crosslinkable acrylic monomer unit may include a carboxy group-containing copolymeric monomer unit, a hydroxy group-containing copolymeric monomer unit, an amino group-containing copolymeric monomer unit, and a glycidyl group-containing copolymeric monomer unit.

Examples of the carboxy group-containing copolymeric monomer may include α,β-unsaturated carboxylic acids, such as acrylic acid, methacrylic acid, crotonic acid, maleic acid, fumaric acid, itaconic acid, citraconic acid or glataconic acid, and the anhydrides thereof.

Examples of the hydroxy group-containing copolymeric monomer may include: hydroxyalkyl (meth)acrylate, such as 2-hydroxyethyl (meth)acrylate, 4-hydroxybutyl (meth)acrylate, or 2-hydroxypropyl (meth)acrylate: [(mono-, di- or poly-)alkylene glycol](meth)acrylate, such as mono(diethylene glycol) (meth)acrylate: and lactone (meth)acrylate such as monocaprolactone (meth)acrylate.

Examples of the amino group-containing copolymeric monomer may include (meth)acrylamide and allylamide.

The glycidyl group-containing copolymeric monomer may be, for example, glycidyl (meth)acrylate.

The acrylic polymer is preferably an acrylic random copolymer, and is more preferably a random copolymer of a crosslinkable acrylic monomer and a non-crosslinkable acrylic monomer. More specifically, the acrylic polymer is preferably a random copolymer of at least one type selected from n-butyl acrylate, 2-ethylhexyl acrylate and methyl acrylate, and acrylic acid, and is more preferably an acrylic acid ester copolymer.

As mentioned above, the acrylic adhesive layer preferably comprises an acrylic copolymer. Among others, the acrylic copolymer comprised in the acrylic adhesive layer preferably comprises a butyl acrylate-derived unit. In this case, the content of the butyl acrylate-derived unit may be 30% by mass or more, and is preferably 35% by mass or more, and more preferably 40% by mass or more, with respect to the total mass of the acrylic copolymer. On the other hand, the content of the butyl acrylate-derived unit is preferably 80% by mass or less, and more preferably 70% by mass or less, with respect to the total mass of the acrylic copolymer. By setting the content of the butyl acrylate-derived unit in the acrylic copolymer to be within the above-described range, the interfacial adhesive force between the acrylic adhesive layer and the silicone adhesive layer can be effectively enhanced, and thereby, the reworkability of the double-sided adhesive sheet can be enhanced.

The acrylic copolymer comprised in the acrylic adhesive layer preferably further comprises a 2-hydroxyethyl acrylate-derived unit, as well as the butyl acrylate-derived unit. In this case, the content of the 2-hydroxyethyl acrylate-derived unit is preferably 10% by mass or more, more preferably 15% by mass or more, and further preferably 20% by mass or more, with respect to the total mass of the acrylic copolymer. On the other hand, the content of the 2-hydroxyethyl acrylate-derived unit is preferably 50% by mass or less, more preferably 45% by mass or less, and further preferably 40% by mass or less, with respect to the total mass of the acrylic copolymer. By setting the content of the 2-hydroxyethyl acrylate-derived unit in the acrylic copolymer to be within the above-described range, the interfacial adhesive force between the acrylic adhesive layer and the silicone adhesive layer can be effectively enhanced, and thereby, the reworkability of the double-sided adhesive sheet can be enhanced.

Moreover, the acrylic copolymer comprised in the acrylic adhesive layer preferably further comprises a 2-methoxyethyl acrylate-derived unit, as well as the butyl acrylate-derived unit. In this case, the content of the 2-methoxyethyl acrylate-derived unit is preferably 10% by mass or more, more preferably 15% by mass or more, and further preferably 20% by mass or more, with respect to the total mass of the acrylic copolymer. On the other hand, the content of the 2-methoxyethyl acrylate-derived unit is preferably 50% by mass or less, more preferably 45% by mass or less, and further preferably 40% by mass or less, with respect to the total mass of the acrylic copolymer. By setting the content of the 2-methoxyethyl acrylate-derived unit in the acrylic copolymer to be within the above-described range, the interfacial adhesive force between the acrylic adhesive layer and the silicone adhesive layer can be effectively enhanced, and thereby, the reworkability of the double-sided adhesive sheet can be enhanced.

The acrylic copolymer comprised in the acrylic adhesive layer preferably has any of the 2-hydroxyethyl acrylate-derived unit or the 2-methoxyethyl acrylate-derived unit, as well as the butyl acrylate-derived unit. Otherwise, the acrylic copolymer may have both the 2-hydroxyethyl acrylate-derived unit and the 2-methoxyethyl acrylate-derived unit, as well as the butyl acrylate-derived unit.

The acrylic copolymer comprised in the acrylic adhesive layer may further comprise other acrylic monomer-derived units. Examples of such other acrylic monomers may include alkyl (meth)acrylate other than the aforementioned acrylic monomers. Examples of the alkyl (meth)acrylate may include methyl (meth)acrylate, ethyl (meth)acrylate, nonyl (meth)acrylate, decyl (meth)acrylate, lauryl (meth)acrylate, and 2-ethylhexyl (meth)acrylate. Among others, the acrylic copolymer preferably comprises a 2-ethylhexyl acrylate-derived unit. The content of the alkyl (meth)acrylate-derived unit is preferably 1% by mass or more, more preferably 5% by mass or more, and further preferably 10% by mass or more, with respect to the total mass of the acrylic copolymer. On the other hand, the content of the alkyl (meth)acrylate-derived unit is preferably 80% by mass or less, and more preferably 70% by mass or less, with respect to the total mass of the acrylic copolymer.

The acrylic copolymer comprised in the acrylic adhesive layer may comprise, as another acrylic monomer, an acrylic monomer-derived unit having a crosslinkable functional group. Examples of the crosslinkable functional group may include a carboxy group, an amino group, an amide group, a glycidyl group, and an isocyanate group. Among others, the crosslinkable functional group is preferably a carboxy group. That is to say, the acrylic copolymer preferably comprises an acrylic acid-derived unit.

As mentioned above, the acrylic copolymer comprised in the acrylic adhesive layer preferably further comprises at least one type selected from a 2-ethylhexyl acrylate-derived unit and an acrylic acid-derived unit, and more preferably further comprises both of the 2-ethylhexyl acrylate-derived unit and the acrylic acid-derived unit.

The acrylic copolymer may have other monomer units, as necessary. Such other monomers may be those that are copolymerizable with the aforementioned acrylic monomer. Examples of such other monomer units may include (meth)acrylonitrile, vinyl acetate, styrene, vinyl chloride, vinyl pyrrolidone, and vinyl pyridine.

Moreover, the acrylic copolymer may further comprise a nitrogen-containing monomer-derived unit. Examples of the nitrogen-containing monomer may include acryloylmorpholine, urethane acrylate, (meth)acrylamide, allylamide, dimethylacrylamide,diethylacrylamide,dimethylaminopropylacrylamide,anddiacetone acrylamide. The content of the nitrogen-containing monomer-derived unit is preferably 5% by mass or more with respect to the total mass of the acrylic copolymer. On the other hand, the content of the nitrogen-containing monomer-derived unit is preferably 70% by mass or less, more preferably 50% by mass or less, further preferably 20% by mass or less, and particularly preferably 10% by mass or less, with respect to the total mass of the acrylic copolymer.

The weight average molecular weight (Mw) of the acrylic copolymer is preferably 200,000 or more and 2,500,000 or less, and more preferably 300,000 or more and 2,000,000 or less. It is to be noted that the weight average molecular weight (Mw) is calculated based on a calibration curve produced using a polystyrene reference material according to gel permeation chromatography (GPC) measurement.

Measurement conditions for the gel permeation chromatography (GPC) are as follows.

### Solvent: Tetrahydrofuran

Column: Shodex KF801, KF803L, and KF806L (Three columns manufactured by SHOWA DENKO K. K. were used by being connected with one another.)
Column temperature: 40° C.
Sample concentration: 0.5% by mass
Detector: RI-2031 plus (manufactured by JASCO)
Pump: RI-2080 plus (manufactured by JASCO)
Flow amount (flow rate): 0.8 ml/min
Injected amount: 10 μl
Calibration curve: A calibration curve was used with 10 samples of polystyrene reference materials, Shodex Standard Polystyrene (manufactured by SHOWA DENKO K. K.) having Mw of 1,320 to 2,500,000.

The acrylic adhesive layer preferably comprises a silane coupling agent. By allowing the acrylic adhesive layer to comprise a silane coupling agent, the interfacial adhesive force between the acrylic adhesive layer and the silicone adhesive layer can be more effectively enhanced. Examples of the silane coupling agent may include: epoxy group-containing silane coupling agents, such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents, such as 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane; (meth)acryl group-containing silane coupling agents, such as 3-acryloxypropyltrimethoxysilane and 3-methacryloxypropyltriethoxysilane; and isocyanate group-containing silane coupling agents such as 3-isocyanatopropyltriethoxysilane. Among others, the silane coupling agent is preferably an epoxy group-containing silane coupling agent.

Otherwise, as such a silane coupling agent, a silane coupling agent having a plurality of alkoxysilyl groups in the molecule thereof can be used. Examples of such a silane coupling agent may include X-41-1053, X-41-1059A, X-41-1056, X-41-1805, X-41-1818, X-41-1810, and X-40-2651, which are manufactured by Shin-Etsu Chemical Co., Ltd.

The content of the silane coupling agent is preferably 0.03% by mass or more and 5% by mass or less, with respect to the total mass of the acrylic adhesive layer. Moreover, the content of the silane coupling agent is preferably 0.06% by mass or more and 1% by mass or less, with respect to the total mass of the acrylic adhesive layer. The silane coupling agent may be used alone, or may also be used in the form of a mixture of two or more types.

The acrylic adhesive layer may comprise a crosslinking agent. That is to say, the acrylic adhesive composition that forms the acrylic adhesive layer preferably comprises a crosslinking agent, and thereby, the crosslinking reaction of the aforementioned crosslinkable acrylic monomer can be promoted. The crosslinking agent can be selected, as appropriate, from known crosslinking agents such as, for example, isocyanate compounds, epoxy compounds, oxazoline compounds, aziridine compounds, metal chelate compounds, butylated melamine compounds and polyfunctional acrylates, while taking into consideration the reactivity of the crosslinking agent with a crosslinkable functional group possessed by the crosslinkable acrylic polymer. The crosslinking mode can be selected from known methods such as thermal crosslinking or ionizing radiation crosslinking. Moreover, in order to further enhance the crosslinking degree, after completion of the formation of an adhesive layer, a curing treatment may be carried out under the environment of 23° C.

Examples of the isocyanate compound may include tolylene diisocyanate, xylylene diisocyanate, hexamethylene diisocyanate, and isoholon diisocyanate. The diisocyanate may be directly used in the form of a bifunctional compound, or may also be used in the form of a trifunctional derivative such as an adduct, nurate or burette.

Examples of the epoxy compound may include ethylene glycol diglycidyl ether, polyethylene glycol diglycidyl ether, propylene glycol diglycidyl ether, polypropylene glycol diglycidyl ether, glycerin diglycidyl ether, neopentyl glycol diglycidyl ether, 1,6-hexanediol diglycidyl ether, tetraglycidyl xylenediamine, 1,3-bis(N,N-diglycidylaminomethyl)cyclohexane, trimethylolpropane polyglycidyl ether, diglycerol polyglycidyl ether, polyglycerol polyglycidyl ether, and sorbitol polyglycidyl ether.

The crosslinking agent may be used alone as a single type, or may also be used in combination of two or more types. The content of the crosslinking agent in the acrylic adhesive composition that forms the acrylic adhesive layer is selected, as appropriate, depending on desired adhesive properties, etc., and is not particularly limited. The content of the crosslinking agent is preferably 0.01 part by mass or more and 5 parts by mass or less, with respect to 100 parts by mass of the acrylic polymer.

The acrylic adhesive layer may comprise a hydrogen abstraction type polymerization initiator. The hydrogen abstraction type polymerization initiator is particularly preferably a photopolymerization initiator. Examples of the hydrogen abstraction type photopolymerization initiator may include benzophenone, benzoylbenzoic acid, methyl benzoylbenzoate, 4-phenylbenzophenone, hydroxybenzophenone, 3,3′-dimethyl-4-methoxybenzophenone, 2,4,6-trimethylbenzophenone, 4-methylbenzophenone, thioxanthone, 2-chloro-thioxanthone, 2-methylthioxanthone, 2,4-dimethylthioxanthone, isopropylthioxanthone, camphorquinone, dibenzosuberone, 2-ethylanthraquinone, 3,3′,4,4′-tetra(t-butylperoxycarbonyl)benzophenone, benzyl, and 9,10-phenanthrenequinone. Among others, the hydrogen abstraction type photopolymerization initiator preferably comprises at least one type selected from benzophenone, 4-methylbenzophenone, and 2,4,6-trimethylbenzophenone. Commercially available products of the hydrogen abstraction type photopolymerization initiator may include Irgacure MBF, Speedcure MBP, Speedcure TZT, Speedcure MBF, Speedcure ITX, Speedcure DETX, Speedcure CPTX, Speedcure MBB, and Speedcure PBZ.

The content of the hydrogen abstraction type polymerization initiator is preferably 0.05% by mass or more and 10% by mass or less, with respect to the total mass of the acrylic adhesive layer.

To the acrylic adhesive layer, additives such as a plasticizer, an antioxidant, a metal corrosion inhibitor, a tackifier, an ultraviolet absorber, an antistatic agent, a photopolymerization initiator, or a light stabilizer such as a hindered amine compound, can be selected and added, as necessary.

As a plasticizer, for example, a non-functional acrylic polymer can be used. The non-functional acrylic polymer means a polymer consisting only of an acrylic monomer unit not having functional groups other than acrylate groups, or a polymer consisting of an acrylic monomer unit not having functional groups other than acrylate groups and a non-acrylic monomer unit not having functional groups.

Examples of the antioxidant may include phenolic antioxidants, amine-based antioxidants, lactone-based antioxidants, phosphorus antioxidants, and sulfur-based antioxidants. These antioxidants may be used alone as a single type, or may also be used in combination of two or more types.

The metal corrosion inhibitor may be a benzotriazole resin.

Examples of the tackifier may include a rosin resin, a terpene resin, a terpene phenolic resin, a coumarone-indene resin, a styrene resin, a xylene resin, a phenolic resin, and a petroleum resin.

Examples of the ultraviolet absorber may include a benzotriazole compound and a benzophenone compound.

Furthermore, in order to prevent deterioration of the acrylic adhesive layer over time, it is preferable to add an anti-ageing agent to the acrylic adhesive layer. By adding such an anti-ageing agent to the acrylic adhesive layer, a reduction in the adhesive force due to deterioration of the double-sided adhesive sheet can be avoided. Examples of the anti-ageing agent may include common phenolic antioxidants, phosphorus antioxidants, ultraviolet inhibitors, and HALS (hindered amine stabilizer).

The acrylic adhesive composition that forms the acrylic adhesive layer may comprise a solvent. Such a solvent is evaporated upon the formation of the adhesive layer, but the acrylic adhesive layer may comprise the remaining solvent.

Examples of the solvent may include: hydrocarbons, such as hexane, heptane, octane, toluene, xylene, ethylbenzene, cyclohexane, or methylcyclohexane; halogenated hydrocarbons, such as dichloromethane, trichloroethane, trichloroethylene, tetrachloroethylene, or dichloropropane: alcohols, such as methanol, ethanol, propanol, isopropyl alcohol, butanol, isobutyl alcohol, or diacetone alcohol: ethers, such as diethyl ether, diisopropyl ether, dioxane, or tetrahydrofuran: ketones, such as acetone, methyl ethyl ketone, methyl isobutyl ketone, isoholon, or cyclohexanone: esters, such as methyl acetate, ethyl acetate, butyl acetate, isobutyl acetate, amyl acetate, or ethyl butylate: and polyols and the derivatives thereof, such as ethylene glycol monomethyl ether, ethylene glycol monoethyl ether, ethylene glycol monomethyl ether acetate, propylene glycol monomethyl ether, propylene glycol monoethyl ether, or propylene glycol monomethyl ether acetate.

### <Silicone Adhesive Layer>

The double-sided adhesive sheet of the present invention comprises a silicone adhesive layer. The silicone adhesive layer is a layer comprising a silicone resin (silicone adhesive) as a main component. Specifically, the content of the silicone resin in the silicone adhesive layer is preferably 50% by mass or more, more preferably 60% by mass or more, further preferably 70% by mass or more, still further preferably 80% by mass or more, and particularly preferably 90% by mass or more, with respect to the total mass of the silicone adhesive layer.

The silicone resin may be, for example, a silicone resin having a polysiloxane skeleton. The silicone resin includes addition reaction type, condensation reaction type, ultraviolet curing type, and electron beam curing type silicone resins. Among these, since the addition reaction type silicone resin has high reactivity and excellent productivity, it is favorably used. The addition reaction type silicone resin may be, for example, organopolysiloxane having two or more alkenyl groups containing 2 to 10 carbon atoms, such as vinyl groups, allyl groups, propenyl groups, or hexenyl groups, at the terminus and/or side chain of a molecule thereof.

When such an addition reaction type silicone resin is used, a crosslinking agent and a catalyst are preferably used in combination with the silicone resin. The crosslinking agent may be, for example, organopolysiloxane having hydrogen atoms bound to at least two silicon atoms in a single molecule thereof. Specific examples of the crosslinking agent may include a dimethyl hydrogen siloxy group terminal blocked dimethyl siloxane-methyl hydrogen siloxane copolymer, a trimethylsiloxy group terminal blocked dimethyl siloxane-methyl hydrogen siloxane copolymer, trimethylsiloxy group terminal blocked methyl hydrogen polysiloxane, and poly(hydrogen silsesquioxane).

Examples of the catalyst may include particulate platinum, particulate platinum adsorbed on a carbon powder carrier, chloroplatinic acid, chloroplatinic acid denatured with alcohol, an olefin complex of chloroplatinic acid, and platinum-group compounds such as palladium and rhodium.

To the silicone adhesive layer, additives such as an antioxidant, a metal corrosion inhibitor, a tackifier, an ultraviolet absorber, a hindered amine compound, an antistatic agent or a light stabilizer, can be selected and added, as necessary.

Examples of the antioxidant may include phenolic antioxidants, amine-based antioxidants, lactone-based antioxidants, phosphorus antioxidants, and sulfur-based antioxidants. These antioxidants may be used alone as a single type, or may also be used in combination of two or more types.

The metal corrosion inhibitor may be a benzotriazole resin.

Examples of the tackifier may include a rosin resin, a terpene resin, a terpene phenolic resin, a coumarone-indene resin, a styrene resin, a xylene resin, a phenolic resin, and a petroleum resin.

Examples of the ultraviolet absorber may include a benzotriazole compound and a benzophenone compound.

Furthermore, in order to prevent deterioration of the silicone adhesive layer over time, it is preferable to add an anti-ageing agent to the silicone adhesive layer. By adding such an anti-ageing agent to the silicone adhesive layer, a reduction in the adhesive force due to deterioration of the double-sided adhesive sheet can be avoided. Examples of the anti-ageing agent may include common phenolic antioxidants, phosphorus antioxidants, ultraviolet inhibitors, and HALS (hindered amine stabilizer).

The silicone adhesive composition that forms the silicone adhesive layer may comprise a solvent. Such a solvent is evaporated upon the formation of the adhesive layer, but the silicone adhesive layer may comprise the remaining solvent. Examples of the solvent may be the same as the solvents that may be comprised in the acrylic adhesive composition.

The silicone adhesive that can be used herein is a commercially available product. Examples of such a silicone adhesive may include: KR-3704 and X40-3306 manufactured by Shin-Etsu Chemical Co., Ltd.; DC7651 ADHESIVE and SD7587 LPSA manufactured by Toray Dow Corning Corporation; and SE9500 and SE9600 manufactured by Aica Kogyo Company, Limited.

### (Method for Producing Double-Sided Adhesive Sheet)

The step of producing the double-sided adhesive sheet of the present invention preferably comprises a step of laminating an acrylic adhesive layer and a silicone adhesive layer on each other. Each adhesive layer is preferably an adhesive layer (adhesive sheet) formed by coating, and is more preferably an adhesive layer (adhesive sheet) formed by serial coating. It is to be noted the term “serial coating” is used in the present description to mean that each adhesive layer is coated in each step, so that individual sheets are formed, separately.

The method for producing a double-sided adhesive sheet comprises, for example, a step of applying an acrylic adhesive composition onto a release sheet to form an acrylic adhesive layer, and a step of applying a silicone adhesive composition onto another release sheet to form a silicone adhesive layer. The production method further comprises a step of laminating an acrylic adhesive layer on a silicone adhesive layer, so that the layers can be directly contacted with each other, followed by pressure bonding.

Application of each adhesive composition can be carried out using a known coating apparatus. Examples of the coating apparatus may include a blade coater, an air knife coater, a roll coater, a bar coater, a gravure coater, a microgravure coater, a rod blade coater, a lip coater, a die coater, and a curtain coater.

After coating, a drying step is preferably performed, and the drying step can be carried out using a known heating device such as a heating furnace or an infrared lamp.

The step of producing the double-sided adhesive sheet preferably comprises a surface activation treatment step before lamination of the acrylic adhesive layer and the silicone adhesive layer. Herein, examples of the surface activation treatment may include a corona treatment and a plasma treatment. Among others, a corona treatment is preferably performed as a surface activation treatment.

In the surface activation treatment step, a surface activation treatment is preferably carried out on at least one selected from the acrylic adhesive layer and the silicone adhesive layer. Herein, the surface activation treatment is preferably carried out on the surface of each adhesive layer on the laminated surface side. Specifically, at least one selected from the surface of the acrylic adhesive layer on the interface side and the surface of the silicone adhesive layer on the interface side is preferably a surface-activation-treated surface. In addition, it is also preferable that the surface activation treatment is carried out on both of the acrylic adhesive layer and the silicone adhesive layer. Specifically, the surface of the acrylic adhesive layer on the interface side and the surface of the silicone adhesive layer on the interface side are preferably surface-activation-treated surfaces. Besides, when the surface activation treatment is only carried out on the surface of either the acrylic adhesive layer or the silicone adhesive layer, the surface activation treatment is preferably carried out on the silicone adhesive layer.

When the surface of the acrylic adhesive layer on the interface side is a surface-activation-treated surface, the wetting tension of the surface-activation-treated surface is preferably 70 mN/m or more, and more preferably 73 mN/m or more. Besides, the upper limit of the wetting tension of the surface-activation-treated surface is not particularly limited. Moreover, the wetting tension of the acrylic adhesive layer after completion of the surface activation treatment is preferably 1.1 times or more higher than the wetting tension of the acrylic adhesive layer before the surface activation treatment. When the surface activation treatment is only carried out on either the acrylic adhesive layer or the silicone adhesive layer, the surface activation treatment is preferably carried out on the acrylic adhesive layer.

When the surface of the silicone adhesive layer on the interface side is a surface-activation-treated surface, the wetting tension of the surface-activation-treated surface is preferably 30 mN/m or more, more preferably 34 mN/m or more, and further preferably 35 mN/m or more. Besides, the upper limit of the wetting tension of the surface-activation-treated surface is not particularly limited. In order to prevent a reduction in transparency, the upper limit of the wetting tension of the surface-activation-treated surface is, for example, preferably 50 m N/m or less, and more preferably 45 m N/m or less. It is to be noted that the wetting tension is measured by applying Wetting Index Standard Solution (manufactured by Wako Pure Chemical Industries, Ltd.) onto the surface of the adhesive layer in accordance with JIS K 6768 1999.

The corona treatment may be, for example, a system of discharging electricity in normal pressure air, using a corona treatment machine. The corona output in the corona treatment is not particularly limited, and it is, for example, preferably 0.5 kW or more and 8.0 kW or less, more preferably 0.5 kW or more and 7.0 kW or less, and further preferably 0.5 kW or more and 6.0 kW or less. The treatment speed in the corona treatment is preferably 5 m/min or more and 100 m/min or less, more preferably 5 m/min or more and 90 m/min or less, and further preferably 5 m/min or more and 80 m/min or less.

The plasma treatment may be, for example, a system of discharging electricity in normal pressure air, using a plasma discharger. The plasma output in the plasma treatment is not particularly limited, and it is, for example, preferably 0.5 kW or more and 5.0 kW or less, more preferably 0.5 kW or more and 3.0 kW or less, and further preferably 0.5 kW or more and 1.5 kW or less. The treatment speed in the plasma treatment is preferably 5 m/min or more and 100 m/min or less, more preferably 5 m/min or more and 90 m/min or less, and further preferably 5 m/min or more and 80 m/min or less.

The degree of surface activation is preferably controlled, as appropriate, so that the wetting tension can be within the aforementioned range.

The pressure-bonding method applied in the step of pressure-bonding the acrylic adhesive layer and the silicone adhesive layer is not particularly limited. A roll laminating machine capable of continuous pressure-bonding is preferably used.

(Double-Sided Adhesive Sheet with Release Sheet(s))

On at least one surface of the double-sided adhesive sheet, a release sheet is preferably laminated, and such release sheets are more preferably laminated on both surfaces of the double-sided adhesive sheet. That is to say, the double-sided adhesive sheet of the present invention is preferably a double-sided adhesive sheet with release sheets, which comprises release sheets on both surfaces of the double-sided adhesive sheet.

Examples of the release sheet may include: a releasable laminated sheet having a base material for release sheet and a release agent layer established on one surface of this base material for release sheet; and polyolefin films used as low polarity base materials, such as a polyethylene film or a polypropylene film.

As a base material for release sheet used in the releasable laminated sheet, a paper or a polymeric film is used. As a release agent constituting the release agent layer, for example, a commonly used, addition type or condensation type silicone-based release agent or a long-chain alkyl group-containing compound is used. In particular, a highly reactive addition type silicone-based release agent is preferably used.

Specific examples of the silicone-based release agent may include: BY24-4527, SD-7220, etc. manufactured by Toray Dow Corning Silicone Co., Ltd.; and KS-3600. KS-774, X62-2600, etc. manufactured by Shin-Etsu Chemical Co., Ltd. In addition, the silicone-based release agent preferably comprises a silicone resin that is an organic silicon compound having an SiO₂ unit and a (CH₃)₃SiO_{1/2} unit or a CH₂═CH(CH₃)SiO_{1/2} unit. Specific examples of the silicone resin may include: BY24-843, SD-7292, SHR-1404, etc. manufactured by Toray Dow Corning Silicone Co., Ltd.; and KS-3800, X92-183, etc. manufactured by Shin-Etsu Chemical Co., Ltd.

When release sheets are laminated on both surfaces of the double-sided adhesive sheet, two release sheets (a first release sheet and a second release sheet) preferably have different release force.

The first release sheet (the release sheet on the acrylic adhesive layer side) is preferably a release sheet on the side of a light release force, and the release force needed upon releasing the first release sheet from the acrylic adhesive layer is preferably 0.01 N/50 mm or more, and more preferably 0.1 N/50 mm or more On the other hand, the release force needed upon releasing the first release sheet from the acrylic adhesive layer is preferably 1.0 N/50 mm or less, more preferably 0.8 N/50 mm or less, and further preferably 0.6 N/50 mm or less.

The second release sheet (the release sheet on the silicone adhesive layer side) is preferably a release sheet on the side of a heavy release force, and the release force needed upon releasing the second release sheet from the silicone adhesive layer is preferably 0.5 N/50 mm or more, and more preferably 0.6 N/50 mm or more. On the other hand, the release force needed upon releasing the second release sheet from the silicone adhesive layer is preferably 10.0 N/50 mm or less, more preferably 5.0 N/50 mm or less, and further preferably 3.0 N/50 mm or less.

When the release force of the second release sheet (the release sheet on the silicone adhesive layer side) is defined as R_{H} and the release force of the first release sheet (the release sheet on the acrylic adhesive layer side) is defined as R_{L}, the value of R_{H}/R_{L} is preferably 1.5 or more, and more preferably 2.0 or more.

### (Double-Sided Adhesive Sheet for Lamination of Optical Members)

The double-sided adhesive sheet of the present invention is preferably used for lamination of various types of members. The intended use of lamination is not limited, and the double-sided adhesive sheet of the present invention is preferably a double-sided adhesive sheet used for lamination of optical members. Examples of the optical member may include a liquid crystal display and a touch panel. In particular, the double-sided adhesive sheet of the present invention is preferably used for lamination of a glass and a liquid crystal display, or lamination of a glass and a touch panel.

### (Laminate)

The present invention may also relate to a laminate having the aforementioned double-sided adhesive sheet and adherents. In this case, the laminate is preferably a laminate, in which the surface attached to a first adherent is an acrylic adhesive layer and the surface attached to a second adherent is a silicone adhesive layer. Among others, the first adherent is preferably a glass. By having such a configuration, the present double-sided adhesive sheet strongly adheres to the first adherent, while it can be easily removed from the second adherent.

### EXAMPLES

The characteristics of the present invention will be more specifically described in the following examples and comparative examples. The materials, used amounts, ratios, treatment contents, treatment procedures, etc., which are shown in the following examples, can be appropriately modified, unless they are deviated from the gist of the present invention. Accordingly, the scope of the present invention should not be restrictively interpreted by the following specific examples.

### Example 1

### <Preparation of Acrylic Adhesive Composition>

90 Parts by mass of n-butyl acrylate (BA) and 10 parts by mass of acrylic acid (AA) were copolymerized to prepare a (meth)acrylic acid ester polymer. The weight average molecular weight of this (meth)acrylic acid ester polymer was 500,000.

100 Parts by mass of the obtained (meth)acrylic acid ester polymer, 0.05 parts by mass of 1,3-bis(N,N′-diglycidylaminomethyl)cyclohexane (TERAD-C, manufactured by Mitsubishi Gas Chemical Company, Inc.) used as an epoxy crosslinking agent, and 0.15 parts by mass of silicone alkoxy oligomer (X-41-1810, manufactured by Shin-Etsu Chemical Co., Ltd.) used as a silane coupling agent were mixed with one another, and thereafter, the thus obtained mixture was fully stirred. The reaction mixture was diluted with ethyl acetate to a solid concentration of 40% by mass, thereby obtaining an acrylic adhesive composition (A).

### <Preparation of Silicone Adhesive Composition>

100 Parts by mass (solid conversion value; the same shall apply hereinafter) of addition type organopolysiloxane (KS-847H, manufactured by Shin-Etsu Chemical Co., Ltd.) consisting of organopolysiloxane, comprising a siloxane bond as a main skeleton and having a vinyl group, and organohydrogenpolysiloxane, 20 parts by mass of organopolysiloxane (silicone resin; SD-4584, manufactured by Toray Dow Corning Corporation) comprising a trifunctional or tetrafunctional siloxane unit, and 1.5 parts by mass of platinum catalyst (SRX-212, manufactured by Toray Dow Corning Corporation) were mixed with one another, and thereafter, the thus obtained mixture was fully stirred. The reaction mixture was diluted with methyl ethyl ketone to a solid concentration of 40% by mass, thereby obtaining a silicone adhesive composition.

### <Production of Double-Sided Adhesive Sheet>

### (Production of Acrylic Adhesive Layer)

Using an applicator, the acrylic adhesive composition (A) was uniformly applied onto the surface of a polyethylene terephthalate film (separator film) (38RL-07(2), manufactured by Oji F-Tex Co., Ltd.) with a thickness of 38 μm, comprising a release agent layer treated with a silicone-based release agent, so that the applied amount of the composition after drying became 50 μm. Thereafter, the resulting film was dried in a constant temperature oven with air circulation at 100° C. for 3 minutes, thereby obtaining an acrylic adhesive layer having a first release sheet attached to one surface thereof. The adhesive layer having a first release sheet attached to one surface thereof was cured in the environment of 23° C. and a relative humidity of 50% for 7 days.

### (Production of Silicone Adhesive Layer)

Using an applicator, the silicone adhesive composition was uniformly applied onto the surface of a polyethylene terephthalate film (Lumirror S-10#38, manufactured by Toray Industries, Inc.) with a thickness of 38 μm, so that the applied amount of the composition after drying became 50 μm. Thereafter, the resulting film was dried in a constant temperature oven with air circulation at 100° C. for 3 minutes, thereby obtaining a silicone adhesive layer having a second release sheet attached to one surface thereof.

### (Surface Activation Treatment)

A corona discharge treatment was carried out on each of the surface of the acrylic adhesive layer and the surface of the silicone adhesive layer. The corona discharge treatment was carried out using a corona surface treatment device manufactured by KASUGA DENKI, Inc. The corona discharge treatment was carried out under the conditions in which the wetting tension of the acrylic adhesive layer became 70 mN/m or more and the wetting tension of the silicone adhesive layer became 30 mN/m or more.

(Production of Double-Sided Adhesive Sheet with Release Sheets)

The surfaces, on which the surface activation treatment had been performed, were laminated on each other, so as to obtain a double-sided adhesive sheet with release sheets, in which the first release sheet, the acrylic adhesive layer, the silicone adhesive layer, and the second release sheet were laminated in this order.

### Example 2

A double-sided adhesive sheet with release sheets was obtained in the same manner as that of Example 1, with the exception that the surface activation treatment performed on each of the acrylic adhesive layer and the silicone adhesive layer in the above (Surface activation treatment) was changed to a plasma discharge treatment (Atmospheric Plasma Surface Treatment Device RT Series, manufactured by Sekisui Chemical Co., Ltd.). The plasma discharge treatment was carried out under the conditions in which the wetting tension of the acrylic adhesive layer became 70 mN/m or more and the wetting tension of the silicone adhesive layer became 30 mN/m or more.

### Example 3

A double-sided adhesive sheet with release sheets was obtained in the same manner as that of Example 1, with the exception that the surface activation treatment was not performed on the silicone adhesive layer in the above (Surface activation treatment). The corona discharge treatment was carried out under the conditions in which the wetting tension of the acrylic adhesive layer became 70 mN/m or more.

### Example 4

A double-sided adhesive sheet with release sheets was obtained in the same manner as that of Example 1, with the exception that the surface activation treatment was not performed on the acrylic adhesive layer in the above (Surface activation treatment). The corona discharge treatment was carried out under the conditions in which the wetting tension of the silicone adhesive layer became 30 mN/m or more.

### Example 5

An acrylic adhesive composition (B) was obtained in the same manner as that of Example 1, with the exception that a silane coupling agent was not used in the above <Preparation of acrylic adhesive composition>. In addition, a double-sided adhesive sheet with release sheets was obtained in the same manner as that of Example 1, with the exception that the acrylic adhesive composition (B) was used instead of the acrylic adhesive composition (A).

### Example 6

In the above <Preparation of acrylic adhesive composition>, 55 parts by mass of 2-ethylhexyl acrylate (2EHA), 40 parts by mass of 4-acryloylmorpholine (ACMO), and 5 parts by mass of acrylic acid (AA) were copolymerized to prepare a (meth)acrylic acid ester polymer. The weight average molecular weight of this (meth)acrylic acid ester polymer was 700,000. An acrylic adhesive composition (C) was obtained in the same manner as that of Example 5, with the exception that this (meth)acrylic acid ester polymer was used. In addition, a double-sided adhesive sheet with release sheets was obtained in the same manner as that of Example 5, with the exception that the acrylic adhesive composition (C) was used instead of the acrylic adhesive composition (B).

### Example 7

In the above <Preparation of acrylic adhesive composition>, 25 parts by mass of n-butyl acrylate (BA), 55 parts by mass of 2-ethylhexyl acrylate (2EHA), 5 parts by mass of diethylacrylamide (DEAA), and 5 parts by mass of 4-acryloylmorpholine (ACMO) were copolymerized to prepare a (meth)acrylic acid ester polymer. The weight average molecular weight of this (meth)acrylic acid ester polymer was 1,000,000. An acrylic adhesive composition (D) was obtained in the same manner as that of Example 5, with the exception that this (meth)acrylic acid ester polymer was used. In addition, a double-sided adhesive sheet with release sheets was obtained in the same manner as that of Example 5, with the exception that the acrylic adhesive composition (D) was used instead of the acrylic adhesive composition (B).

### Example 8

In the above <Preparation of acrylic adhesive composition>, 90 parts by mass of 2-ethylhexyl acrylate (2EHA) and 10 parts by mass of acrylic acid (AA) were copolymerized to prepare a (meth)acrylic acid ester polymer. The weight average molecular weight of this (meth)acrylic acid ester polymer was 500.000. 100 Parts by mass of the obtained (meth)acrylic acid ester polymer, 0.05 parts by mass of 1,3-bis(N,N′-diglycidylaminomethyl)cyclohexane (TERAD-C, manufactured by Mitsubishi Gas Chemical Company, Inc.) used as an epoxy crosslinking agent, and 1.5 parts by mass of 4-methylbenzophenone used as a hydrogen abstraction type photopolymerization initiator were mixed with one another, and thereafter, the thus obtained mixture was fully stirred. The reaction mixture was diluted with ethyl acetate to a solid concentration of 40% by mass, thereby obtaining an acrylic adhesive composition (E). A double-sided adhesive sheet with release sheets was obtained in the same manner as that of Example 5, with the exception that the acrylic adhesive composition (E) was used instead of the acrylic adhesive composition (B). Thereafter, the obtained double-sided adhesive sheet with release sheets was irradiated with ultraviolet light (high pressure mercury), so that the integrated amount of light became 1000 mJ/cm², thereby obtaining a double-sided adhesive sheet with release sheets, which was to be finally used in evaluation.

### Comparative Example 1

### <Production of Adhesive Laminate>

A double-sided adhesive sheet with release sheets was obtained in the same manner as that of Example 1, with the exception that a surface activation treatment was performed neither on the acrylic adhesive layer nor on the silicone adhesive layer in the above (Surface activation treatment).

### Comparative Example 2

### <Production of Adhesive Laminate>

A double-sided adhesive sheet with release sheets was obtained in the same manner as that of Example 5, with the exception that a surface activation treatment was performed neither on the acrylic adhesive layer nor on the silicone adhesive layer in the above (Surface activation treatment).

### (Measurement and Evaluation)

### <Measurement of Adhesive Force>

### (Adhesive Force of Acrylic Adhesive Layer)

To the adhesive surface of the acrylic adhesive layer obtained in the above (Production of acrylic adhesive layer), which is the opposite surface of a first release sheet had been attached, a polyethylene terephthalate film with a highly adhesive layer (A4300#100, manufactured by Toyobo Co., Ltd.) was attached as a lining base material. The first release sheet was removed, and the adhesive surface of the acrylic adhesive layer was then attached to a soda-lime glass. At twenty-four hours after the attachment, the adhesive force was measured in accordance with Method 1 of JIS Z 0237, under conditions of a peeling rate of 300 mm/min and a peeling angle of 180°.

### (Adhesive Force of Silicone Adhesive Layer)

A first release sheet was removed from a double-sided adhesive sheet with release sheets, in which the first release sheet, an acrylic adhesive layer, a silicone adhesive layer, and a second release sheet were laminated in this order, and a polyethylene terephthalate film with a highly adhesive layer (A4300#100, manufactured by Toyobo Co., Ltd.) was then attached thereto as a lining base material. Thereafter, the second release sheet was removed from the double-sided adhesive sheet, and the adhesive surface of the silicone adhesive layer was then attached to a soda-lime glass. At twenty-four hours after the attachment, the adhesive force was measured in accordance with Method 1 of JIS Z 0237, under conditions of a peeling rate of 300 mm/min and a peeling angle of 180°.

### <Wetting Tension>

The wetting tension was measured by applying Wetting Index Standard Solution (manufactured by Wako Pure Chemical Industries, Ltd.) onto the surface of an adhesive layer in accordance with JIS K 6768 1999.

### <Interfacial Adhesive Force>

[Production of Adhesive Tape with Base Material for Lining]

90 Parts by mass of n-butyl acrylate (BA) and 10 parts by mass of acrylic acid (AA) were copolymerized to prepare a (meth)acrylic acid ester polymer. The weight average molecular weight of this (meth)acrylic acid ester polymer was 500,000.

100 Parts by mass of the obtained (meth)acrylic acid ester polymer, 0.05 parts by mass of 1,3-bis(N,N′-diglycidylaminomethyl)cyclohexane (TERAD-C, manufactured by Mitsubishi Gas Chemical Company, Inc.) used as an epoxy crosslinking agent, and 5 parts by mass of silicone alkoxy oligomer (X-41-1810, manufactured by Shin-Etsu Chemical Co., Ltd.) used as a silane coupling agent were mixed with one another, and thereafter, the thus obtained mixture was fully stirred. The reaction mixture was diluted with ethyl acetate to a solid concentration of 40% by mass, thereby obtaining an acrylic adhesive composition for use in an adhesive tape with a base material for lining.

Using an applicator, the obtained acrylic adhesive composition was uniformly applied onto the surface of a polyethylene terephthalate film with a highly adhesive layer (A4300#100, manufactured by Toyobo Co., Ltd.), so that the applied amount of the composition after drying became 25 μm. Thereafter, the resulting film was dried in a constant temperature oven with air circulation at 100° C. for 3 minutes, thereby obtaining an adhesive tape with a base material for lining.

### [Production of Sample for Measurement of Interfacial Adhesive Force]

A “first release sheet” was removed from the “first release sheet/acrylic adhesive layer/silicone adhesive layer/second release sheet” obtained in each of the Examples and Comparative Examples, and thereafter, a “polyethylene terephthalate film with a highly adhesive layer (A4300#100, manufactured by Toyobo Co., Ltd.)” was attached to the acrylic adhesive layer surface. From the thus obtained “polyethylene terephthalate film with a highly adhesive layer/acrylic adhesive layer/silicone adhesive layer/second release sheet,” the “second release sheet” was removed. Thereafter, using a corona surface treatment device manufactured by KASUGA DENKI, Inc., a surface activation treatment was performed on the surface of the silicone adhesive layer, so that the wetting tension became 34 mN/m or more. Furthermore, using the corona surface treatment device manufactured by KASUGA DENKI, Inc., a surface activation treatment was performed on the surface of the acrylic adhesive layer of the adhesive tape with a base material for lining, so that the wetting tension of the acrylic adhesive layer became 73 mN/m or more.

Subsequently, to the silicone adhesive layer surface of the “polyethylene terephthalate film with a highly adhesive layer/acrylic adhesive layer/silicone adhesive layer,” on which the surface activation treatment had been performed, the acrylic adhesive layer surface of the “adhesive tape with a base material for lining,” on which the surface activation treatment had been performed, was attached, so as to obtain a sample for the measurement of interfacial adhesive force having a configuration of the “polyethylene terephthalate film with a highly adhesive layer/acrylic adhesive layer/silicone adhesive layer/adhesive tape with a base material for lining.”

### [Measurement of Interfacial Adhesive Force]

At twenty-four hours after the “polyethylene terephthalate film with a highly adhesive layer/acrylic adhesive layer/silicone adhesive layer/adhesive tape with a base material for lining” had been obtained as described above (i.e., at twenty-four hours after the attachment of the silicone adhesive layer surface to the acrylic adhesive layer surface, both of which had been subjected to the surface activation treatment), the side of the adhesive tape with a base material for lining was removed in accordance with Method 1 of JIS Z 0237, under conditions of a peeling rate of 300 mm/min and a peeling angle of 180°, so that the adhesive force at the interface between the “acrylic adhesive layer/silicone adhesive layer” was measured.

### <Evaluation of Reworkability>

A double-sided adhesive sheet with release sheets, in which a first release sheet, an acrylic adhesive layer, a silicone adhesive layer, and a second release sheet were laminated in this order, were cut into a size of 25×50 mm square, and the first release sheet was then removed therefrom. After that, a slide glass (S9112, manufactured by Matsunami Glass Ind., Ltd., size: 76×52 mm) was attached to the acrylic adhesive layer (by one round trip of a 2-kg roller). Thereafter, the second release sheet was removed, and the silicone adhesive layer was attached to a soda-lime glass (S9112, manufactured by Matsunami Glass Ind., Ltd., size: 76×52 mm). The thus obtained double-sided adhesive sheet with glass plates on both surfaces thereof was equipped in a universal tensile testing machine (Tensilon UTM-4-100, manufactured by Orientec Co., Ltd.), and the silicone adhesive layer was then removed from the slide glass in accordance with JIS Z 0237, under conditions of a peeling rate of 300 mm/min and a peeling angle of 90° (removed upwards). Reworkability was evaluated according to the following criteria.

“Excellent”: No adhesive layer remains on the surface of a slide glass, when a silicone adhesive layer is attached to the slide glass, is then left in the environment of 40° C. and a relative humidity of 90% for 240 hours, and is then removed.
“Good”: No adhesive layer remains on the surface of a slide glass, when a silicone adhesive layer is attached to a slide glass, is then left in the environment of 40° C. and a relative humidity of 90% for 24 hours, and is then removed. However, when the silicone adhesive layer attached to the slide glass is left in the environment of 40° C. and a relative humidity of 90% for 240 hours, and is then removed, the adhesive layer remains on the surface of the slide glass.
“Fair”: No adhesive layer remains on the surface of a slide glass, when a silicone adhesive layer is attached to a soda-lime glass, is then left in the environment of 23° C. and a relative humidity of 50% for 30 minutes, and is then removed. However, when the silicone adhesive layer attached to the slide glass is left in the environment of 40° C. and a relative humidity of 90% for 24 hours, and is then removed, the adhesive layer remains on the surface of the slide glass.
“Poor”: An adhesive layer remains on the surface of a slide glass, when a silicone adhesive layer is attached to a soda-lime glass, is then left in the environment of 23° C. and a relative humidity of 50% for 30 minutes, and is then removed.

TABLE 1

| | | | | | | | | | | | Comp. | Comp. |
|---|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 1 | Ex. 2 |
| Acrylic | Acrylic adhesive | Type | A | A | A | A | B | C | D | E | A | B |
| adhesive | composition | | | | | | | | | | | |
| layer | Silane coupling agent | Mass | 0.15 | 0.15 | 0.15 | 0.15 | 0 | 0 | 0 | 0 | 0.15 | 0 |
| | | % | | | | | | | | | | |
| | Wetting tension before | mN/m | 64 | 64 | 64 | 64 | 63 | 63 | 65 | 64 | 64 | 64 |
| | surface activation | | | | | | | | | | | |
| | Surface activation | | Corona | Plasma | Corona | Un- | Corona | Corona | Corona | Corona | Un- | Un- |
| | method | | | | | treated | | | | | treated | treated |
| | Wetting tension after | mN/m | 73 | 73 | 73 | — | 73 | 76 | 75 | 71 | — | — |
| | surface activation | | | | | | | | | | | |
| | Adhesive force to | N/25 | 12 | 12 | 12 | 12 | 12 | 15 | 15 | 12 | 12 | 12 |
| | glass | mm | | | | | | | | | | |
| Silicone | Wetting tension before | mN/m | 22.6 or | 22.6 or | 22.6 or | 22.6 or | 22.6 or | 22.6 or | 22.6 or | 22.6 or | 22.6 or | 22.6 or |
| adhesive | surface activation | | less | less | less | less | less | less | less | less | less | less |
| layer | Surface activation | | Corona | Plasma | Un- | Corona | Corona | Corona | Corona | Corona | Un- | Un- |
| | method | | | | treated | | | | | | treated | treated |
| | Wetting tension after | mN/m | 31 | 34 | — | 34 | 34 | 34 | 34 | 34 | — | — |
| | surface activation | | | | | | | | | | | |
| | Adhesive force to | N/25 | 0.12 | 0.12 | 0.12 | 0.12 | 0.12 | 0.12 | 0.12 | 0.12 | 0.1 | 0.1 |
| | glass | mm | | | | | | | | | | |

| | | | | | | | | | | | |
|---|---|---|---|---|---|---|---|---|---|---|---|
| Adhesive force of adhesive | N/25 | 17 | 15 | 3 | 1 | 11 | 20 | 19 | 17 | 0.1 | 0.1 |
| layer at interface | mm | | | | | | | | | | |
| Reworkability | | Ex- | Ex- | Fair | Fair | Good | Ex- | Ex- | Ex- | Poor | Poor |
| | | cellent | cellent | | | | cellent | cellent | cellent | | |

In the case of the double-sided adhesive sheets obtained in the Examples, the acrylic adhesive layer exhibited strong adhesive force to the glass, and the silicone adhesive layer was excellent in terms of reworkability. In contrast, in the case of the double-sided adhesive sheets obtained in the Comparative Examples, the adhesive layer remained on the adherent upon reworking.

### Example 101

### <Preparation of Acrylic Adhesive Composition>

40 Parts by mass of n-butyl acrylate, 55 parts by mass of 2-ethylhexyl acrylate, and 5 parts by mass of acrylic acid were copolymerized to prepare an acrylic copolymer. The weight average molecular weight of this acrylic copolymer was 1,000,000.

100 Parts by mass of the obtained acrylic copolymer, 0.05 parts by mass of 1,3-bis(N,N′-diglycidylaminomethyl)cyclohexane (TERAD-C, manufactured by Mitsubishi Gas Chemical Company, Inc.) used as an epoxy crosslinking agent, and 0.15 parts by mass of silicone alkoxy oligomer (X-41-1810, manufactured by Shin-Etsu Chemical Co., Ltd.) used as a silane coupling agent were mixed with one another, and thereafter, the thus obtained mixture was fully stirred. The reaction mixture was diluted with ethyl acetate to a solid concentration of 40% by mass, thereby obtaining an acrylic adhesive composition (A).

### <Preparation of Silicone Adhesive Composition>

100 Parts by mass (solid conversion value; the same shall apply hereinafter) of addition type organopolysiloxane (KS-847H, manufactured by Shin-Etsu Chemical Co., Ltd.) consisting of organopolysiloxane, comprising a siloxane bond as a main skeleton and having a vinyl group, and organohydrogenpolysiloxane, 20 parts by mass of organopolysiloxane (silicone resin: SD-4584, manufactured by Toray Dow Corning Corporation) comprising a trifunctional or tetrafunctional siloxane unit, and 1.5 parts by mass of platinum catalyst (SRX-212, manufactured by Toray Dow Corning Corporation) were mixed with one another, and thereafter, the thus obtained mixture was fully stirred. The reaction mixture was diluted with methyl ethyl ketone to a solid concentration of 40% by mass, thereby obtaining a silicone adhesive composition.

### <Production of Double-Sided Adhesive Sheet>

### (Production of Acrylic Adhesive Layer)

Using an applicator, the acrylic adhesive composition (A) was uniformly applied onto the surface of a polyethylene terephthalate film (separator film) (38RL-07(2), manufactured by Oji F-Tex Co., Ltd.) with a thickness of 38 μm, comprising a release agent layer treated with a silicone-based release agent, so that the applied amount of the composition after drying became 50 μm. Thereafter, the resulting film was dried in a constant temperature oven with air circulation at 100° C. for 3 minutes, thereby obtaining an acrylic adhesive layer having a first release sheet attached to one surface thereof. The adhesive layer having a first release sheet attached to one surface thereof was cured in the environment of 23° C. and a relative humidity of 50% for 7 days.

### (Production of Silicone Adhesive Layer)

Using an applicator, the silicone adhesive composition was uniformly applied onto the surface of a polyethylene terephthalate film (Lumirror S-10#38, manufactured by Toray Industries, Inc.) with a thickness of 38 μm, so that the applied amount of the composition after drying became 50 μm. Thereafter, the resulting film was dried in a constant temperature oven with air circulation at 100° C. for 3 minutes, thereby obtaining a silicone adhesive layer having a second release sheet attached to one surface thereof.

### (Surface Activation Treatment)

A corona discharge treatment was carried out on the surface of the silicone adhesive layer. The corona discharge treatment was carried out using a corona surface treatment device manufactured by KASUGA DENKI, Inc. The corona discharge treatment was carried out under the conditions in which the wetting tension of the silicone adhesive layer became 30 mN/m or more.

(Production of Double-Sided Adhesive Sheet with Release Sheets)

The surface-activation-treated surface of the silicone adhesive layer, on which the surface activation treatment had been performed, was laminated on the acrylic adhesive layer, thereby obtaining a double-sided adhesive sheet with release sheets, in which the first release sheet, the acrylic adhesive layer, the silicone adhesive layer, and the second release sheet were laminated in this order.

### Example 102

A double-sided adhesive sheet with release sheets was obtained in the same manner as that of Example 101, with the exception that 40 parts by mass of n-butyl acrylate, 30 parts by mass of 2-hydroxyethyl acrylate, 25 parts by mass of 2-ethylhexyl acrylate, and 5 parts by mass of acrylic acid were copolymerized to prepare an acrylic copolymer. The weight average molecular weight of the obtained acrylic copolymer was 1,500,000.

### Example 103

A double-sided adhesive sheet with release sheets was obtained in the same manner as that of Example 101, with the exception that 40 parts by mass of n-butyl acrylate, 30 parts by mass of 2-methoxyethyl acrylate, 25 parts by mass of 2-ethylhexyl acrylate, and 5 parts by mass of acrylic acid were copolymerized to prepare an acrylic copolymer. The weight average molecular weight of the obtained acrylic copolymer was 1,500,000.

### Example 104

A double-sided adhesive sheet with release sheets was obtained in the same manner as that of Example 101, with the exception that the surface activation treatment performed on the silicone adhesive layer was changed from the corona discharge treatment to a plasma discharge treatment. It is to be noted that the plasma discharge treatment was carried out under conditions in which the wetting tension of the silicone adhesive layer became 30 mN/m or more.

### Comparative Example 101

A double-sided adhesive sheet with release sheets was obtained in the same manner as that of Example 101, with the exception that 55 parts by mass of 2-ethylhexyl acrylate, 40 parts by mass of methyl methacrylate, and 5 parts by mass of acrylic acid were copolymerized to prepare an acrylic copolymer. The weight average molecular weight of the obtained acrylic copolymer was 500,000.

### Comparative Example 102

A double-sided adhesive sheet with release sheets was obtained in the same manner as that of Example 101, with the exception that 10 parts by mass of n-butyl acrylate, 55 parts by mass of 2-ethylhexyl acrylate, 30 parts by mass of methyl methacrylate, and 5 parts by mass of acrylic acid were copolymerized to prepare an acrylic copolymer. The weight average molecular weight of the obtained acrylic copolymer was 1,000,000.

### (Measurement and Evaluation)

The above <Measurement of adhesive force>, <Wetting tension>, <Interfacial adhesive force>, and <Evaluation of reworkability> were carried out in the same methods as described above.

TABLE 2

| | | | | | | | Comp. | Comp. |
|---|---|---|---|---|---|---|---|---|
| | | | Ex. 101 | Ex. 102 | Ex. 103 | Ex. 104 | Ex. 101 | Ex. 102 |
| Acrylic copolymer | Butyl acrylate | Part by mass | 40 | 40 | 40 | 40 | 0 | 10 |
| | 2-Hydroxyethyl acrylate | Part by mass | 0 | 30 | 0 | 0 | 0 | 0 |
| | 2-Methoxyethyl acrylate | Part by mass | 0 | 0 | 30 | 0 | 0 | 0 |
| | 2-Ethylhexyl acrylate | Part by mass | 55 | 25 | 25 | 55 | 55 | 55 |
| | Methyl methacrylate | Part by mass | 0 | 0 | 0 | 0 | 40 | 30 |
| | Acrylic acid | Part by mass | 5 | 5 | 5 | 5 | 5 | 5 |

| | | | | | | | |
|---|---|---|---|---|---|---|---|
| Adhesive force of acrylic adhesive layer to glass | N/25 mm | 12 | 15 | 14 | 12 | 10 | 10 |
| Release force of release sheet from acrylic adhesive | N/50 mm | 0.1 | 0.1 | 0.1 | 0.1 | 0.1 | 0.1 |
| layer | | | | | | | |
| Adhesive force of silicone adhesive layer to glass | N/25 mm | 0.1 | 0.1 | 0.1 | 0.1 | 0.1 | 0.1 |
| Release force of release sheet on silicone adhesive | N/50 mm | 0.8 | 0.8 | 0.8 | 0.8 | 0.8 | 0.8 |
| layer side | | | | | | | |
| Surface activation method for silicone adhesive layer | — | Corona | Corona | Corona | Plasma | Corona | Corona |
| Wetting tension of surface-activation-treated surface | mN/m | 40 | 40 | 40 | 40 | 40 | 40 |
| Interfacial adhesive force | N/25 mm | 10 | 18 | 18 | 10 | 0.1 | 0.1 |
| Reworkability | | Good | Excellent | Excellent | Good | Poor | Poor |

In the case of the double-sided adhesive sheets obtained in the Examples, the acrylic adhesive layer exhibited strong adhesive force to the glass, and the silicone adhesive layer was excellent in terms of reworkability. In contrast, in the case of the double-sided adhesive sheets obtained in the Comparative Examples, the adhesive layer remained on the adherent upon reworking.

Moreover, the double-sided adhesive sheets obtained in the Examples were also excellent in terms of curved surface followability or step followability.

### REFERENCE SIGNS LIST

10 Acrylic adhesive layer
12 Silicone adhesive layer
100 Double-sided adhesive sheet

1. A double-sided adhesive sheet having:
an acrylic adhesive layer, and
a silicone adhesive layer directly laminated on the acrylic adhesive layer, wherein
the interfacial adhesive force between the acrylic adhesive layer and the silicone adhesive layer is 1 N/25 mm or more.

2. The double-sided adhesive sheet according to claim 1, wherein
the acrylic adhesive layer has an acrylic copolymer comprising a unit derived from butyl acrylate, and
the content of the butyl acrylate-derived unit is 30% by mass or more with respect to the total mass of the acrylic copolymer.

3. The double-sided adhesive sheet according to claim 2, wherein
the acrylic copolymer further comprises a unit derived from 2-hydroxyethyl acrylate, and
the content of the 2-hydroxyethyl acrylate is 10% by mass or more and 50% by mass or less, with respect to the total mass of the acrylic copolymer.

4. The double-sided adhesive sheet according to claim 2, wherein
the acrylic copolymer further comprises a unit derived from 2-methoxyethyl acrylate, and
the content of the 2-methoxyethyl acrylate-derived unit is 10% by mass or more and 50% by mass or less, with respect to the total mass of the acrylic copolymer.

5. The double-sided adhesive sheet according to claim 2, wherein the acrylic copolymer further comprises at least one type selected from a unit derived from 2-ethylhexyl acrylate and a unit derived from acrylic acid.

6. The double-sided adhesive sheet according to claim 1, wherein at least one selected from the surface of the acrylic adhesive layer on the interface side and the surface of the silicone adhesive layer on the interface side is a surface-activation-treated surface.

7. The double-sided adhesive sheet according to claim 1, wherein the surface of the acrylic adhesive layer on the interface side is a surface-activation-treated surface, and the wetting tension of the surface-activation-treated surface is 70 mN/m or more.

8. The double-sided adhesive sheet according to claim 1, wherein the surface of the silicone adhesive layer on the interface side is a surface-activation-treated surface, and the wetting tension of the surface-activation-treated surface is 30 mN/m or more.

9. The double-sided adhesive sheet according to claim 1, wherein
the acrylic adhesive layer comprises a silane coupling agent, and
the content of the silane coupling agent is 0.03% by mass or more and 5% by mass or less, with respect to the total mass of the acrylic adhesive layer.

10. The double-sided adhesive sheet according to claim 1, wherein
the acrylic adhesive layer comprises an acrylic copolymer comprising a unit derived from a nitrogen-containing monomer, and the content of the nitrogen-containing monomer-derived unit is 5% by mass or more and 70% by mass or less, with respect to the total mass of the acrylic copolymer.

11. The double-sided adhesive sheet according to claim 1, wherein the acrylic adhesive layer comprises a hydrogen abstraction type polymerization initiator, and the content of the hydrogen abstraction type polymerization initiator is 0.05% by mass or more and 10% by mass or less, with respect to the total mass of the acrylic adhesive layer.

12. The double-sided adhesive sheet according to claim 11, wherein the hydrogen abstraction type polymerization initiator is a photopolymerization initiator.

13. The double-sided adhesive sheet according to claim 1, wherein the adhesive force of the acrylic adhesive layer to a glass is 1 N/25 mm or more.

14. The double-sided adhesive sheet according to claim 13, wherein the adhesive force of the acrylic adhesive layer to a glass is 30 N/25 mm or less.

15. The double-sided adhesive sheet according to claim 1, wherein the adhesive force of the silicone adhesive layer to a glass is 0.005 N/25 mm or more and 1 N/25 mm or less.

16. A double-sided adhesive sheet with release sheets, comprising release sheets on both surfaces of the double-sided adhesive sheet according to claim 1.
